(19) United States
(12) Patent Application Publication
(10) Pub. No.: US 2018/0100471 A1
(43) Pub. Date: Apr. 12, 2018

(54) LOW TEMPERATURE COOLING DEVICE FOR INTERNAL COMBUSTION ENGINE

(71) Applicant: DENSO CORPORATION, Kariya-city, Aichi-pref. (JP)

(72) Inventors: Keitarou MINAMI, Kariya-city (JP); Masashi MIYAGAWA, Kariya-city (JP); Hideaki ICHIHARA, Kariya-city (JP)

(21) Appl. No.: 15/569,194

(22) PCT Filed: Apr. 14, 2016
(86) PCT No.: PCT/JP2016/002027

§ 371 Date: Oct. 25, 2017

(30) Foreign Application Priority Data
May 7, 2015 (JP) 2015-94785

(51) Int. Cl. F02M 26/33; F01P 7/16; F01P 3/18; F02M 26/28; F02M 26/35

(52) U.S. Cl. CPC F02M 26/33; F01P 7/16; F01P 2007/146; F02M 26/28; F02M 26/35; F01P 3/18

(57) ABSTRACT

A low temperature cooling device applied to an internal combustion engine includes an EGR device returning a part of an exhaust gas of an internal combustion engine to an intake passage as an EGR gas, a low temperature coolant circuit circulating a coolant through an intercooler cooling an intake gas of the internal combustion engine and an EGR cooler cooling the EGR gas, a flow rate control valve regulating a flow rate ratio between the coolant flowing into the intercooler and the coolant flowing into the EGR cooler, and a control unit varying the flow rate ratio between the coolant flowing into the intercooler and the coolant flowing into the EGR cooler by controlling the flow rate control valve according to an outside air environment and an operating state of the internal combustion engine.

### CROSS REFERENCE TO RELATED APPLICATION

This application is based on Japanese Patent Application No. 2015-94785 filed on May 7, 2015, the disclosure of which is incorporated herein by reference.

### TECHNICAL FIELD

The present disclosure relates to a low temperature cooling device applied to an internal combustion engine which includes a low temperature coolant circuit circulating a coolant through an intercooler and an EGR cooler.

### BACKGROUND ART

An internal combustion engine installed to a vehicle is equipped with an EGR device which returns a part of an exhaust gas to an intake passage as an EGR gas with an aim of enhancing fuel efficiency and reducing knocking and an emission of an exhaust gas. However, when an EGR gas with a high water content is returned to the intake passage, condensate water may be produced when an intake gas, which is a mixture of the EGR gas and intake air (fresh air), is cooled in an intercooler. The condensate water possibly gives rise to a corrosion of a metal part.

A technique of restricting production of condensate water in the intercooler is described in, for example, Patent Literature 1. According to the disclosed technique, a coolant circuit circulating a coolant through an intercooler and an EGR cooler is provided, and condensate water is forcedly produced by cooling an EGR gas in the EGR cooler. The condensate water is collected into a trap portion to dehumidify the EGR gas. The EGR gas is then heated in an EGR heater to lower a relative humidity and returned to an intake passage.

### PRIOR ART LITERATURES

### Patent Literature

Patent Literature 1: JP2009-174444A

### SUMMARY OF INVENTION

Inventors of the present disclosure have discovered a new problem as follows while conducting a study on a system including a low temperature coolant circuit circulating a coolant through an intercooler and an EGR cooler.

That is, in a low temperature state where an outside air temperature is low, when a flow rate of a coolant flowing into the EGR cooler is low, an EGR gas may not be cooled low enough in the EGR cooler to sufficiently dehumidify the EGR gas. Moreover, in the low temperature state where an outside air temperature is low, a temperature of the coolant falls, too. Hence, when a flow rate of the coolant flowing into the intercooler is high, an intake gas may be supercooled to or below a dew-point temperature (a temperature at or below which condensate water is produced) in the intercooler and condensate water may possibly be produced.

Meanwhile, in a high temperature state where an outside air temperature is high, a temperature of the coolant rises, too. Hence, when a flow rate of the coolant flowing into the intercooler is low, the intake gas may not be cooled sufficiently in the intercooler, in which case in-cylinder charging efficiency of the intake gas may decrease and an output of an internal combustion engine may be reduced. In a high-temperature high-humidity state where an outside air temperature is high and an outside air humidity is high, a dew-point temperature of the intake gas rises. Hence, when a flow rate of the coolant flowing into the intercooler is exceedingly high, the intake gas may be supercooled to or below the dew-point temperature in the intercooler and condensate water may possibly be produced.

The present disclosure has an object to provide a low temperature cooling device applied to an internal combustion engine which cools an intake gas while restricting production of condensate water independently of an outside air environment.

According to an aspect of the present disclosure, the low temperature cooling device applied to the internal combustion engine includes an EGR device returning a part of an exhaust gas of an internal combustion engine to an intake passage as an EGR gas, a low temperature coolant circuit circulating a coolant through an intercooler cooling an intake gas of the internal combustion engine and an EGR cooler cooling the EGR gas, a flow rate control valve regulating a flow rate ratio between the coolant flowing into the intercooler and the coolant flowing into the EGR cooler, and a control unit varying the flow rate ratio between the coolant flowing into the intercooler and the coolant flowing into the EGR cooler by controlling the flow rate control valve according to an outside air environment and an operating state of the internal combustion engine.

By varying a flow rate ratio between the intercooler and the EGR cooler by controlling the flow rate control valve according to an outside air environment and an engine operating state, a flow rate of the intercooler and a flow rate of the EGR cooler can be varied according to the outside air environment and the engine operating state. A flow rate of the intercooler and a flow rate of the EGR cooler can be thus controlled to coincide with respective proper flow rates for the outside air environment that is presently taken into consideration. Consequently, the intake gas can be cooled while restricting production of condensate water independently of an outside air environment.

### BRIEF DESCRIPTION OF DRAWINGS

The above and other objects, features and advantages of the present disclosure will become more apparent from the following detailed description made with reference to the accompanying drawings. In the drawings:

FIG. 1 is a view showing a schematic configuration of an engine control system according to a first embodiment of the present disclosure;

FIG. 2 is a view showing a schematic configuration of a low temperature cooling system of the first embodiment;

FIG. 3 shows a chart used to describe a relationship of an outside air environment and a proper flow rate;

FIG. 4 shows a first half of a flowchart depicting a processing flow of a flow rate control routine of the first embodiment;

FIG. 5 shows a second half of the flowchart depicting the processing flow of the flow rate control routine of the first embodiment;

FIG. 6 shows a flowchart depicting a processing flow of a fail-safe control routine;

FIG. 7 is a flowchart depicting a processing flow of a flow rate control routine of a second embodiment;

FIG. 8 is a conceptual view showing an example of a map of a flow rate proportion of an EGR cooler;

FIG. 9 is a view showing an example of a schematic configuration of a low temperature cooling system of a third embodiment; and

FIG. 10 is a view showing another example of a schematic configuration of the low temperature cooling system of the third embodiment.

### DESCRIPTION OF EMBODIMENTS

Hereinafter, concrete embodiments for carrying out the present disclosure will be described.

### First Embodiment

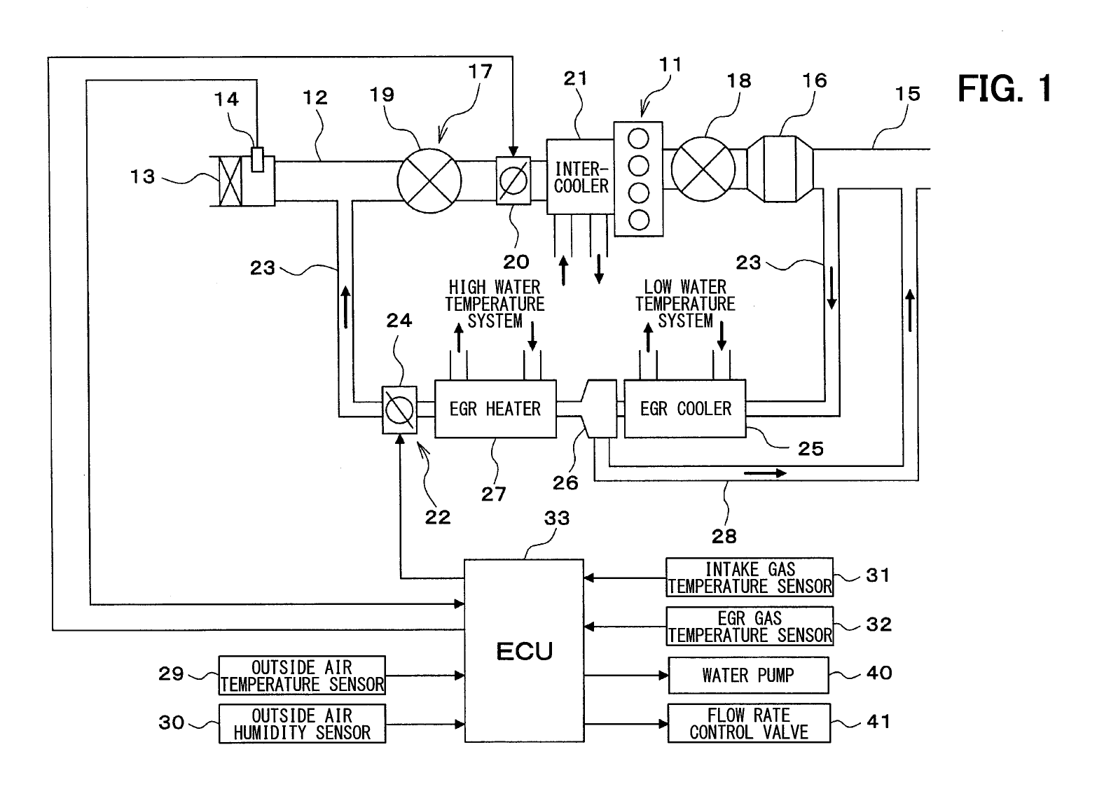

A first embodiment of the present disclosure will be described according to FIG. 1 through FIG. 6.

A schematic configuration of an engine control system will be described first according to FIG. 1.

An air cleaner 13 is provided uppermost-stream of an intake pipe 12 (intake passage) of an internal combustion engine 11 (hereinafter, referred to simply as an engine 11). An air flow meter 14 detecting an amount of intake air is provided downstream of the air cleaner 13. Meanwhile, a catalyst 16, such as a three-way catalyst purifying CO, HC, and NOx in an exhaust gas, is provided to an exhaust pipe 15 of the engine 11.

The engine 11 is equipped with a supercharger 17 supercharging an intake gas into the engine 11. The supercharger 17 is an exhaust turbine driving type. The intake gas can be intake air (fresh air) alone or a mixed gas of intake air and an EGR gas. The supercharger 17 includes an exhaust turbine 18 provided upstream of the catalyst 16 in the exhaust pipe 15, and a compressor 19 provided downstream of the air flow meter 14 in the intake pipe 12. The exhaust turbine 18 and the compressor 19 are coupled to rotate as one unit. Hence, the supercharger 17 supercharges the intake gas into the engine 11 using the compressor 19 which is rotationally driven by rotationally driving the exhaust turbine 18 with kinetic energy of an exhaust gas.

A throttle valve 20 is provided downstream of the compressor 19 in the intake pipe 12 and an opening degree of the throttle valve 20 is regulated by a motor (not shown). An intercooler 21 cooling the intake gas and a surge tank (not shown) are integrally provided downstream of the throttle valve 20. The intercooler 21 is a water cooling type. The intercooler 21 uses a coolant and cools the intake gas which has been supercharged by the supercharger 17 and therefore become hot. Consequently, in-cylinder charging efficiency of the intake gas can be increased, which can in turn enhance an output of the engine 11.

A fuel injection valve (not shown) performing in-cylinder injection or intake port injection is attached to each cylinder of the engine 11. Sparking plugs (not shown) for respective cylinders are attached to a cylinder head of the engine 11 to ignite an air-fuel mixture in the respective cylinders with a spark discharge by the corresponding sparking plugs.

An EGR device 22 that is an LPL (Low Pressure Loop) type and returns a part of an exhaust gas from the exhaust pipe 15 to the intake pipe 12 as an EGR gas is equipped to the engine 11. The EGR device 22 includes an EGR pipe 23 connected between a downstream side of the exhaust turbine 18 in the exhaust pipe 15 (for example, downstream of the catalyst 16) and an upstream side of the compressor 19 in the intake pipe 12. An EGR valve 24 regulating a flow rate of the EGR gas is provided to the EGR pipe 23. An EGR cooler 25 cooling the EGR gas, a separator 26 separating and collecting condensate water in the EGR gas which has passed through the EGR cooler 25, and an EGR heater 27 heating the EGR gas which has passed through the separator 26 are also provided to the EGR pipe 23. The EGR cooler 25 is a water cooling type.

The EGR cooler 25 forcedly produces condensate water by cooling the EGR gas with the coolant in a low water temperature system as the coolant of the intercooler 21. The separator 26 separates and collects the condensate water in the EGR gas. The condensate water collected at the separator 26 is discharged to the exhaust pipe 15 through a pipe 28. The EGR heater 27 heats the EGR gas with the coolant in a high water temperature system as a coolant of the engine 11 to lower a relative humidity of the EGR gas.

An outside air temperature sensor 29 detecting an outside air temperature (To) and an outside air humidity sensor 30 detecting an outside air humidity are provided to a place less susceptible to heat of the engine 11, such as upstream of the intake pipe 12 or an outside of the intake pipe 12. An intake gas temperature sensor 31 detecting a temperature of the intake gas which has passed through the intercooler 21 is provided downstream of the intercooler 21 (for example, the surge tank or an intake manifold). An EGR gas temperature sensor 32 detecting a temperature of the EGR gas which has passed through the EGR cooler 25 is provided downstream of the EGR cooler 25 (for example, between the EGR cooler 25 and the separator 26 or between the separator 26 and the EGR heater 27).

Outputs of the foregoing sensors are inputted into an electronic control unit (ECU) 33. The ECU 33 is chiefly formed of a micro-computer and controls an amount of fuel injection, ignition timing, a throttle opening degree (amount of intake air), and so on according to an engine operating state by running various engine control programs pre-stored in an internal ROM (storage medium).

The ECU 33 calculates a target EGR ratio according to an engine operating state (for example, an engine speed and an engine load), and controls an opening degree of the EGR valve 24 to reach the target EGR ratio.

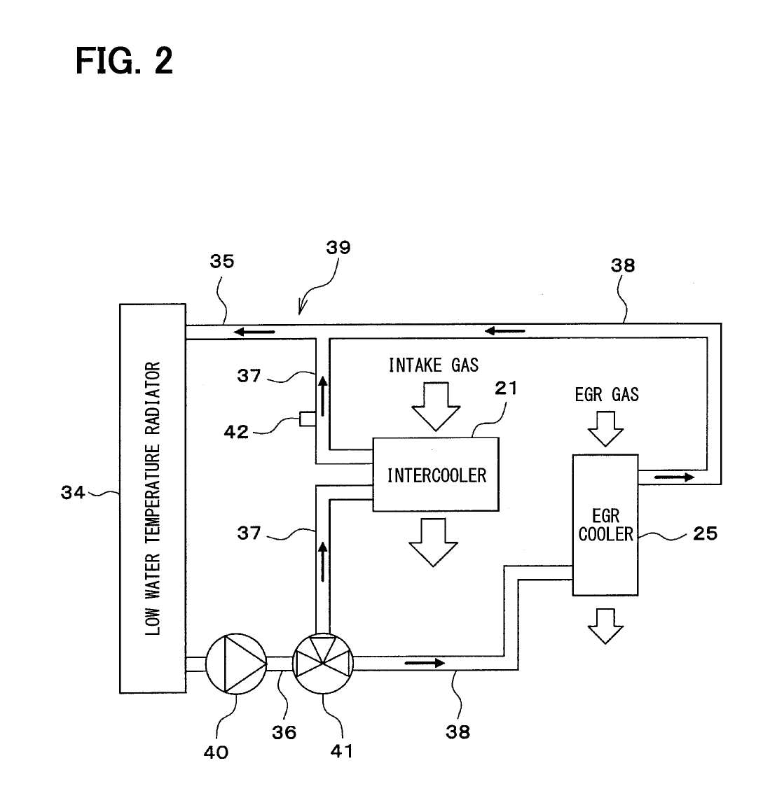

A schematic configuration of a low temperature cooling system will now be described according to FIG. 2.

An intercooler channel 37 to circulate the coolant through the intercooler 21 and an EGR cooler channel 38 to circulate the coolant through the EGR cooler 25 are connected in parallel between an inlet channel 35 connected to an inlet port of a low water temperature radiator 34 and an outlet channel 36 connected to an outlet port of the low water temperature radiator 34. A low temperature coolant circuit 39 cooling the coolant in the low water temperature radiator 34 circulate through the intercooler 21 and the EGR cooler 25 is thus formed.

The low temperature coolant circuit 39 includes a water pump 40 provided to the outlet channel 36, and a flow rate control valve 41 located at a branch point of the intercooler channel 37 and the EGR cooler channel 38. The water pump 40 is an electric driving type. The flow rate control valve 41 is driven on a motor or the like and regulates a flow rate ratio between the coolant flowing to the intercooler 21 and the coolant flowing into the EGR cooler 25 according to an operating position of a valve body. The flow rate control valve 41 has a self-return function by which the valve body is pushed in a direction to an initial position (a position at which a flow rate proportion of the coolant flowing into the intercooler 21 reaches a maximum) to return the valve body to the initial position when energization is stopped for the flow rate proportion of the coolant flowing into the intercooler 21 to reach a maximum (for example, 100%).

A coolant temperature sensor 42 detecting a temperature of the coolant which has passed through the intercooler 21 is provided to the intercooler channel 37. The ECU 33 regulates a flow rate of the coolant flowing into the intercooler 21 by a feedback control by controlling the flow rate control valve 41 and the water pump 40 to lessen a deviation between a coolant temperature detected at the coolant temperature sensor 42 and a target coolant temperature.

In a case where the EGR gas with a high water content is returned to the intake pipe 12, condensate water may be produced when the intake gas, which as a mixture of the EGR gas and intake air (fresh air), is cooled in the intercooler 21. The condensate water possibly gives rise to a corrosion of a metal part.

In order to eliminate such an inconvenience, the EGR gas is dehumidified by forcedly producing condensate water by cooling the EGR gas in the EGR cooler 25 and separating and collecting the condensate water in the EGR gas by the separator 26. The EGR gas is then heated in the EGR heater 27 to lower a relative humidity and returned to the intake pipe 12.

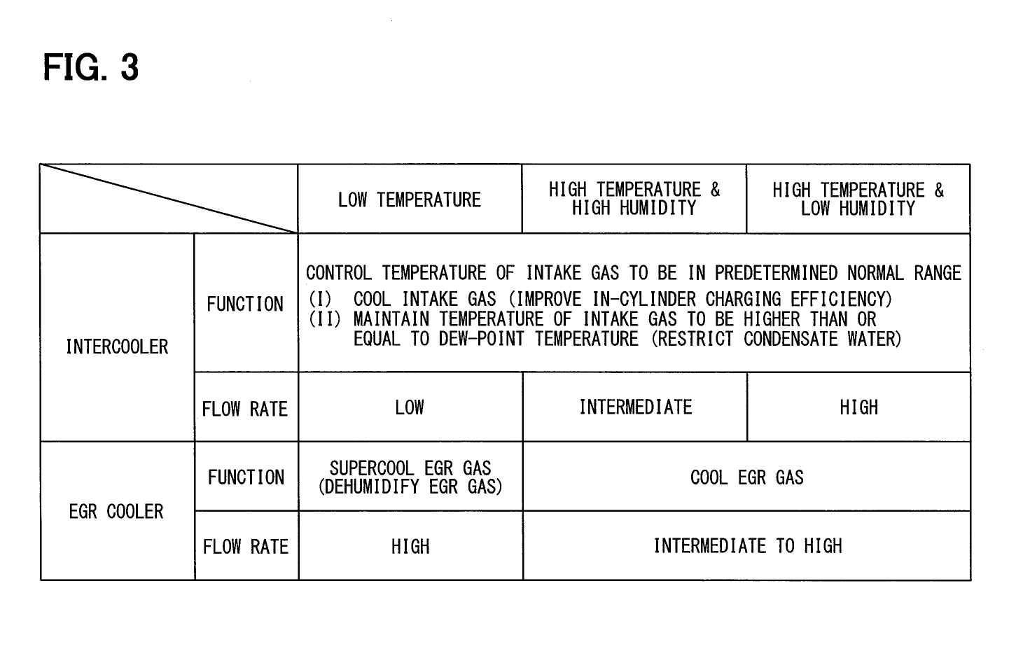

However, as is set forth in FIG. 3, a proper flow rate of the coolant flowing into the intercooler 21 (a flow rate at which the intercooler 21 functions properly) and a proper flow rate of the coolant flowing into the EGR cooler 25 (a flow rate at which the EGR cooler 25 functions properly) vary with an outside air environment (for example, an outside air temperature and an outside air humidity).

In the following description, a flow rate ratio between the coolant flowing into the intercooler 21 and the coolant flowing into the EGR cooler 25 is referred to also simply as a flow rate ratio (Rc) between the intercooler 21 and the EGR cooler 25. The flow rate proportion of the coolant flowing into the intercooler 21 is referred to also simply as a flow rate proportion (Ric) of the intercooler 21, and a flow rate proportion of the coolant flowing into the EGR cooler 25 is referred to also simply as a flow rate proportion (Rec) of the EGR cooler 25. A flow rate of the coolant flowing into the intercooler 21 is referred to also simply as a flow rate of the intercooler 21 and a flow rate of the coolant flowing into the EGR cooler 25 is referred to also simply as a flow rate of the EGR cooler 25.

In a low temperature state where an outside air temperature is low, when a flow rate of the EGR cooler 25 is low, the EGR gas may not be cooled low enough in the EGR cooler 25 to sufficiently dehumidify the EGR gas. Moreover, in the low temperature state where an outside air temperature is low, a temperature of the coolant falls, too. Hence, when a flow rate of the intercooler 21 is high, the intake gas may be supercooled to or below a dew-point temperature (a temperature at or below which condensate water is produced) in the intercooler 21 and condensate water may possibly be produced.

Meanwhile, in a high temperature state where an outside air temperature is high, a temperature of the coolant rises, too. Hence, when a flow rate of the intercooler 21 is low, the intake gas may not be cooled sufficiently in the intercooler 21, in which case in-cylinder charging efficiency of the intake gas may decrease and an output of the engine 11 may be reduced. In a high-temperature high-humidity state where an outside air temperature is high and an outside air humidity is high, a dew-point temperature of the intake gas rises. Hence, when a flow rate of the intercooler 21 is exceedingly high, the intake gas may be supercooled to or below the dew-point temperature in the intercooler 21 and condensate water may possibly be produced.

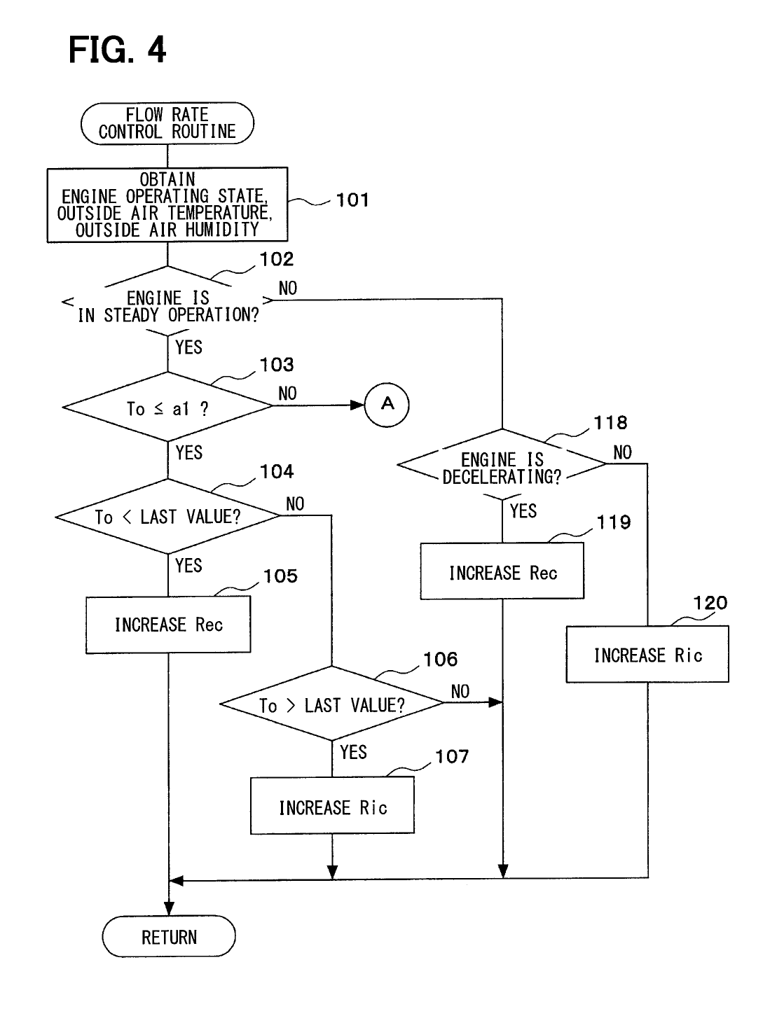

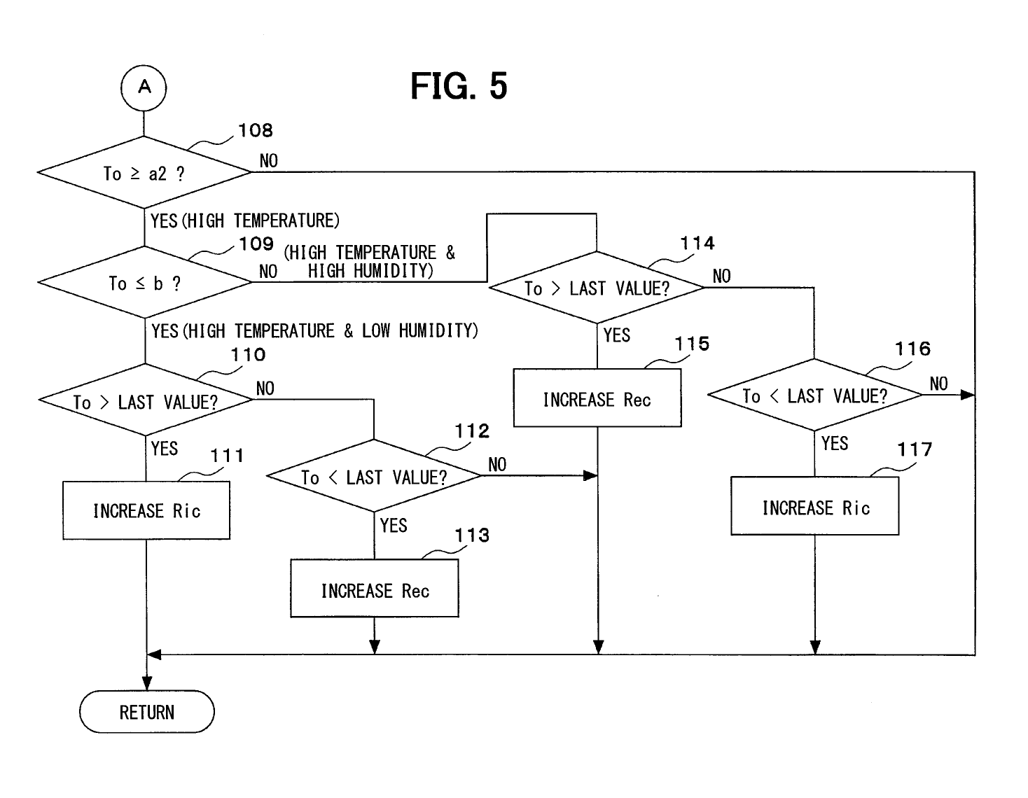

In order to prevent the inconveniences as above, the ECU 33 of the first embodiment performs a flow rate control routine of FIG. 4 and FIG. 5 to vary a flow rate ratio between the intercooler 21 and the EGR cooler 25 by controlling the flow rate control valve 41 according to an outside air environment (for example, an outside air temperature and an outside air humidity) and an engine operating state. The ECU 33 and the flow rate control valve 41 correspond to a low temperature cooling device for an internal combustion engine.

By varying a flow rate ratio between the intercooler 21 and the EGR cooler 25 by controlling the flow rate control valve 41 according to an outside air environment and an engine operating state, a flow rate of the intercooler 21 and a flow rate of the EGR cooler 25 can be varied according to the outside air environment and the engine operating state. A flow rate of the intercooler 21 and a flow rate of the EGR cooler 25 can be thus controlled to coincide with respective proper flow rates for the outside air environment that is presently taken into consideration. Consequently, the intake gas can be cooled while restricting production of condensate water independently of an outside air environment (for example, an outside air temperature and an outside air humidity).

More specifically, in the low temperature state where an outside air temperature is in a predetermined low temperature region (for example, a region where an outside air temperature is at or below a first threshold a1), the ECU 33 controls the flow rate control valve 41 to increase the flow rate proportion of the EGR cooler 25 (that is, to reduce the flow rate proportion of the intercooler 21) as the outside air temperature falls. Accordingly, condensate water is produced by increasing a flow rate of the EGR cooler 25 and thereby cooling the EGR gas sufficiently in the EGR cooler 25 in the low temperature state, and the EGR gas is sufficiently dehumidified. Although a temperature of the coolant falls in the low temperature state, the intake gas is cooled to fall within a predetermined temperature range higher than the dew-point temperature by reducing a flow rate of the intercooler 21 and thereby preventing the intake gas from being supercooled to or below the dew-point temperature in the intercooler 21.

In a high-temperature low-humidity state where an outside air temperature is in a predetermined high temperature region (for example, a region where an outside air temperature is at or above a second threshold a2) and an outside air humidity is in a predetermined low humidity region (for example, a region where an outside air humidity is at or below a third threshold b), the ECU 33 controls the flow rate control valve 41 to increase the flow rate proportion of the intercooler 21 as the outside air temperature rises. Accordingly, although a temperature of the coolant rises in the high-temperature low-humidity state, the intake gas is cooled to fall within the predetermined temperature range higher than the dew-point temperature in the intercooler 21 by increasing a flow rate of the intercooler 21.

In a high-temperature high-humidity state where an outside air temperature is in the high temperature region and an outside air humidity is in a predetermined high humidity region (for example, a region where an outside air humidity is above the third threshold b), the ECU 33 controls the flow rate control valve 41 to reduce the flow rate proportion of the intercooler 21 below the flow rate proportion in the high-temperature low-humidity state. Accordingly, although a dew-point temperature of the intake gas rises in the high-temperature high-humidity state, the intake gas is cooled to fall within the predetermined temperature range higher than the dew-point temperature by reducing a flow rate of the intercooler 21 below the flow rate in the high-temperature low-humidity state and thereby preventing the intake gas from being supercooled to or below the dew-point temperature in the intercooler 21.

In a system configured to regulate a flow rate of the intercooler 21 by a feedback control according to an output of the coolant temperature sensor 42, the intake gas may possibly be supercooled in the intercooler 21 when a flow rate of the intake gas decreases due to deceleration of the engine 11 and a flow rate of the coolant flowing into the intercooler 21 temporarily becomes high for a flow rate of the intake gas.

In order to prevent such an inconvenience, the ECU 33 regulates the flow rate proportion of the intercooler 21 by a feed forward control according to an engine operating state. More specifically, the ECU 33 controls the flow rate control valve 41 by a feed forward control to reduce the flow rate proportion of the intercooler 21 when the engine 11 is decelerating. A flow rate of the coolant flowing into the intercooler 21 is thus reduced quickly when a flow rate of the intake gas decreases due to deceleration of the engine 11.

The following will describe a processing content of the flow rate control routine of FIG. 4 and FIG. 5 performed by the ECU 33 in the first embodiment.

The flow rate control routine depicted in FIG. 4 and FIG. 5 is performed repetitively in predetermined cycles while a power supply of the ECU 33 is ON, and functions as a control unit. When the routine is started, an engine operating state (for example, an engine load and an engine speed), an outside air temperature detected at the outside air temperature sensor 29, and an outside air humidity detected at the outside air humidity sensor 30 are obtained first in 101.

Subsequently, advancement is made to 102, in which whether the engine 11 is in steady operation is determined according to, for example, whether an absolute value of a variation in engine load or engine speed per predetermined time is equal to or less than a predetermined value.

When it is determined in 102 that the engine 11 is in steady operation, advancement is made to 103, in which whether the outside air temperature is in the low temperature region at or below the first threshold al is determined. The first threshold al may be a preliminarily set fixed value or may vary with an engine operating state (for example, an engine load and an engine speed).

When it is determined in 103 that the outside air temperature is in the low temperature region at or below the first threshold al, a present state is determined as being the low temperature state and advancement is made to 104, in which whether the outside air temperature is below a last value (lower than a last outside air temperature) is determined.

When it is determined in 104 that the outside air temperature is below the last value, advancement is made to 105, in which the flow rate control valve 41 is controlled to increase the flow rate proportion of the EGR cooler 25 by a predetermined value. The flow rate control valve 41 is thus controlled to increase the flow rate proportion of the EGR cooler 25 (that is, to reduce the flow rate proportion of the intercooler 21) as an outside air temperature falls in the low temperature state.

By contrast, when it is determined in 104 that the outside air temperature is at or above the last value, advancement is made to 106, in which whether the outside air temperature is above the last value is determined. When it is determined in 106 that the outside air temperature is above the last value, advancement is made to 107, in which the flow rate control valve 41 is controlled to increase the flow rate proportion of the intercooler 21 by a predetermined value.

Meanwhile, when it is determined in 103 that the outside air temperature is above the first threshold a1, advancement is made to 108 of FIG. 5, in which whether the outside air temperature is in the high temperature region at or above the second threshold a2 is determined. Herein, the second threshold a2 is a value greater than a value of the first threshold a1, and may be a preliminarily set fixed value or may vary with an engine operating state (for example, an engine load and an engine speed).

When it is determined in 108 that the outside air temperature is in the high temperature region at or above the second threshold value a2, a present state is determined as being the high temperature state and advancement is made to 109, in which whether the outside air humidity is in the low humidity region at or below the third threshold b is determined. The third threshold b may be a preliminarily set fixed value or may vary with an engine operating state (for example, an engine load and an engine speed).

When it is determined in 109 that the outside air humidity is in the low humidity region at or below the third threshold b, a present state is determined as being the high-temperature low-humidity state and advancement is made to 110, in which whether the outside air temperature is above the last value is determined.

When it is determined in 110 that the outside air temperature is above the last value, advancement is made to 111, in which the flow rate control valve 41 is controlled to increase the flow rate proportion of the intercooler 21 by a predetermined value. The flow rate control valve 41 is thus controlled to increase the flow rate proportion of the intercooler 21 (that is, to reduce the flow rate proportion of the EGR cooler 25) as an outside air temperature rises in the high-temperature low-humidity state.

By contrast, when it is determined in 110 that the outside air temperature is at or below the last value, advancement is made to 112, in which whether the outside air temperature is below the last value is determined. When it is determined in 112 that the outside air temperature is below the last value, advancement is made to 113, in which the flow rate control valve 41 is controlled to increase the flow rate proportion of the EGR cooler 25 by a predetermined value.

Meanwhile, when it is determined in 109 that the outside air humidity is in the high humidity region above the third threshold b, a present state is determined as being the high-temperature high-humidity state and advancement is made to 114, in which whether the outside air temperature is above the last value is determined.

When it is determined in 114 that the outside air temperature is above the last value, advancement is made to 115, in which the flow rate control valve 41 is controlled to increase the flow rate proportion of the EGR cooler 25 by a predetermined value. The flow rate control valve 41 is thus controlled to reduce the flow rate proportion of the intercooler 21 below the flow rate proportion in the high-temperature low-humidity state by controlling the flow rate control valve 41 to increase the flow rate proportion of the EGR cooler 25 (that is, to reduce the flow rate proportion of the intercooler 21) as the outside air temperature rises in the high-temperature high-humidity state.

By contrast, when it is determined in 114 that the outside air temperature is at or below the last value, advancement is made to 116, in which whether the outside air temperature is below the last value is determined. When it is determined in 116 that the outside air temperature is below the last value, advancement is made to 117, in which the flow rate control valve 41 is controlled to increase the flow rate proportion of the intercooler 21 by a predetermined value.

Meanwhile, when it is determined in 102 of FIG. 4 that the engine 11 is not in steady operation, advancement is made to 118, in which whether the engine 11 is decelerating is determined according to, for example, whether an amount of decrease in engine load or engine speed per predetermined time is at or above a predetermined value.

When it is determined in 118 that the engine 11 is decelerating, advancement is made to 119, in which the flow rate control valve 41 is controlled to increase the flow rate proportion of the EGR cooler 25 by a predetermined value. The flow rate control valve 41 is thus controlled to reduce the flow rate proportion of the intercooler 21 by a feed forward control when the engine 11 is decelerating.

By contrast, when it is determined in 118 that the engine 11 is not decelerating, advancement is made to 120, in which the flow rate control valve 41 is controlled to increase the flow rate proportion of the intercooler 21 by a predetermined value.

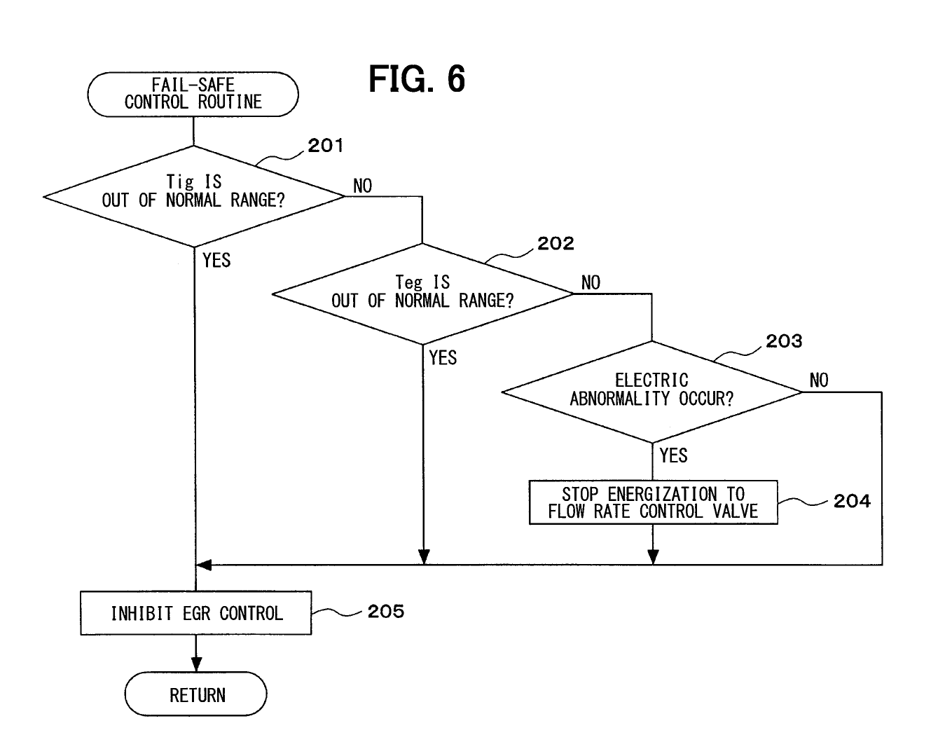

A processing content of a fail-safe control routine of FIG. 6 performed by the ECU 33 in the first embodiment will now be described.

The fail-safe control routine shown in FIG. 6 is performed repetitively in predetermined cycles while the power supply of the ECU 33 is ON, and functions as a fail-safe control unit. When the routine is started, whether an intercooler passed gas temperature (Tig) (that is, a temperature of the intake gas which has passed through the intercooler 21) detected at the intake gas temperature sensor 31 is out of a normal range that is predetermined is determined first in 201.

When it is determined in 201 that the intercooler passed gas temperature is out of the normal range, an abnormality in the low temperature coolant circuit 39 is determined and advancement is made to 205, in which an EGR control is inhibited to inhibit the EGR gas from flowing back by keeping the EGR valve 24 closed. The low temperature coolant circuit 39 includes the intercooler 21, the EGR cooler 25, the low water temperature radiator 34, the channels 35 to 38, the water pump 40, the flow rate control valve 41, and so on.

Meanwhile, when it is determined in 201 that the intercooler passed gas temperature falls within the normal range, advancement is made to 202, in which whether an EGR cooler passed gas temperature (Teg) (that is, a temperature of the EGR gas which has passed through the EGR cooler 25) detected at the EGR gas temperature sensor 32 is out of a normal range that is predetermined is determined.

When it is determined in 202 that the EGR cooler passed gas temperature is out of the normal range, an abnormality in the low temperature coolant circuit 39 is determined and advancement is made to 205, in which the EGR control is inhibited to inhibit the EGR gas from flowing back by keeping the EGR valve 24 closed.

Meanwhile, when it is determined in 202 that the EGR cooler passed gas temperature falls within the normal range, advancement is made to 203, in which whether an electric abnormality is occurring in the flow rate control valve 41 is determined.

When an electric abnormality in the flow rate control valve 41 is determined in 203, advancement is made to 204, in which energization to the flow rate control valve 41 is stopped. Hence, the valve body of the flow rate control valve 41 returns to the initial position and the flow rate proportion of the intercooler 21 reaches a maximum (for example, 100%).

Subsequently, advancement is made to 205, in which the EGR control is inhibited to inhibit the EGR gas from flowing back by keeping the EGR valve 24 closed.

In the first embodiment described above, the flow rate control valve 41 is controlled to increase the flow rate proportion of the EGR cooler 25 (that is, to reduce the flow rate proportion of the intercooler 21) as an outside air temperature falls in the low temperature state where the outside air temperature is in the predetermined low temperature region. When configured in the manner as above, condensate water can be produced by increasing a flow rate of the EGR cooler 25 and thereby sufficiently cooling the EGR gas in the EGR cooler 25 in the low temperature state, and the EGR gas can be sufficiently dehumidified. Although a temperature of the coolant falls in the low temperature state, the intake gas can be cooled to fall within the predetermined temperature range higher than the dew-point temperature by reducing a flow rate of the intercooler 21 and thereby preventing the intake gas from being supercooled to or below the dew-point temperature in the intercooler 21. Consequently, a reduction in in-cylinder charging efficiency (a reduction in output of the engine 11) can be prevented by cooling the intake gas appropriately while restricting production of condensate water in the intercooler 21 in the low temperature state.

In the first embodiment, the flow rate control valve 41 is controlled to increase the flow rate proportion of the intercooler 21 as an outside air temperature rises in the high-temperature low-humidity state where an outside air temperature is in the predetermined high temperature region and an outside air humidity is in the predetermined low humidity region. When configured in the manner as above, although a temperature of the coolant rises in the high-temperature low-humidity state, the intake gas can be cooled to fall within the predetermined temperature range higher than the dew-point temperature in the intercooler 21 by increasing a flow rate of the intercooler 21. Hence, a reduction in in-cylinder charging efficiency (a reduction in output of the engine 11) can be prevented by cooling the intake gas appropriately while restricting production of condensate water in the intercooler 21 in the high-temperature low-humidity state.

In the first embodiment, in the high-temperature high-humidity state where an outside air temperature is in the predetermined high temperature region and an outside air humidity is in the predetermined high humidity region, the flow rate control valve 41 is controlled to reduce the flow rate proportion of the intercooler 21 below the flow rate proportion in the high-temperature low-humidity state. When configured in the manner as above, although a dew-point temperature of the intake gas rises in the high-temperature high-humidity state, the intake gas can be cooled to fall within the predetermined temperature range higher than the dew-point temperature by reducing a flow rate of the intercooler 21 below the flow rate in the high-temperature low-humidity state and thereby preventing the intake gas from being supercooled to or below the dew-point temperature in the intercooler 21. Consequently, a reduction in in-cylinder charging efficiency (a reduction in output of the engine 11) can be prevented by cooling the intake gas appropriately while restricting production of condensate water in the intercooler 21 in the high-temperature high-humidity state.

In the first embodiment, the flow rate control valve 41 is controlled by a feed forward control to reduce the flow rate proportion of the intercooler 21 when the engine 11 is decelerating. When configured in the manner as above, when a flow rate of the intake gas decreases due to deceleration of the engine 11, a flow rate of the coolant flowing into the intercooler 21 can be reduced quickly. The intake gas can be thus prevented from being supercooled in the intercooler 21.

In the first embodiment, the intercooler channel 37 and the EGR cooler channel 38 are connected in parallel and the flow rate control valve 41 is located at a branch point of the intercooler channel 37 and the EGR cooler channel 38. Owing to the configuration as above, a flow rate ratio between the intercooler 21 and the EGR cooler 25 can be varied in a reliable manner by the flow rate control valve 41.

In a case where an intercooler channel and an EGR cooler channel are connected in series, a temperature of the coolant flowing downstream of an intercooler and an EGR cooler becomes higher than a temperature of the coolant flowing upstream. By contrast, the intercooler channel 37 and the EGR cooler channel 38 are connected in parallel in the first embodiment. Hence, the coolant at substantially a same temperature flows into the intercooler 21 and the EGR cooler 25.

In the first embodiment, an abnormality in the low temperature coolant circuit 39 is determined when the intercooler passed gas temperature is out of the predetermined normal range or when the EGR cooler passed gas temperature is out of the predetermined normal range, and the EGR gas is inhibited from flowing back. When configured in the manner as above, production of condensate water in the intercooler 21 can be restricted by inhibiting the EGR gas from flowing back in the event of an abnormality in the low temperature coolant circuit 39.

In the first embodiment, the flow rate control valve 41 has the self-return function of returning to a state in which the flow rate proportion of the intercooler 21 reaches a maximum when energization is stopped, and energization to the flow rate control valve 41 is stopped and the EGR gas is inhibited from flowing back when an electric abnormality in the flow rate control valve 41 is determined. When configured in the manner as above, the EGR gas is inhibited from flowing back in the event of an electric abnormality in the flow rate control valve 41 to secure intake gas cooling performance by increasing the flow rate proportion of the intercooler 21 to a maximum while restricting production of condensate water in the intercooler 21.

In the first embodiment, the separator 26 separating and collecting condensate water in the EGR gas which has passed through the EGR cooler 25 and the EGR heater 27 heating the EGR gas which has passed through the separator 26 are provided. Hence, an effect of restricting production of condensate water in the intercooler 21 can be enhanced.

### Second Embodiment

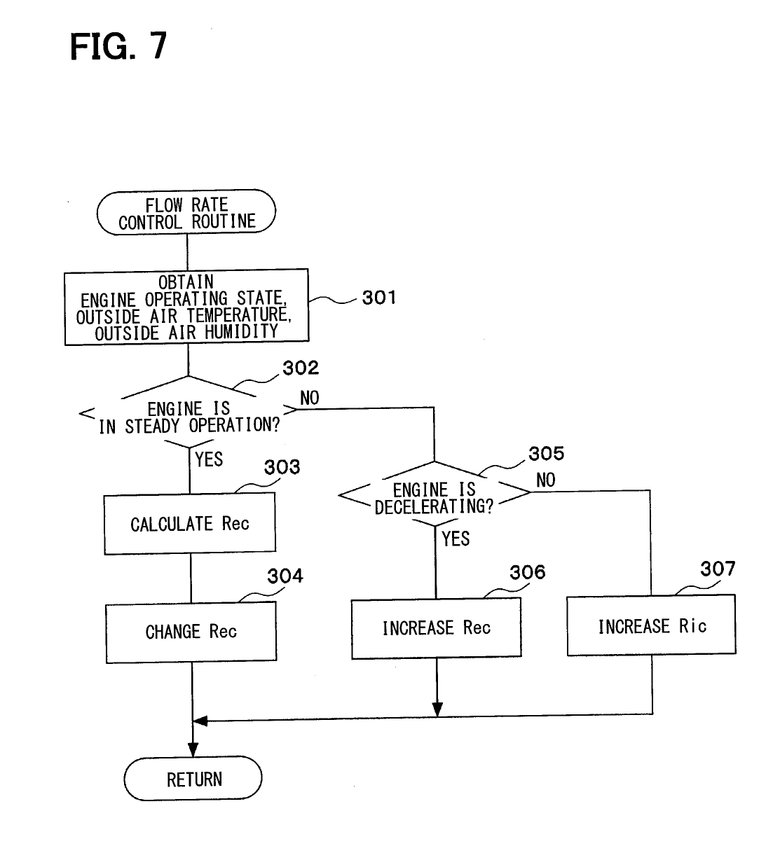

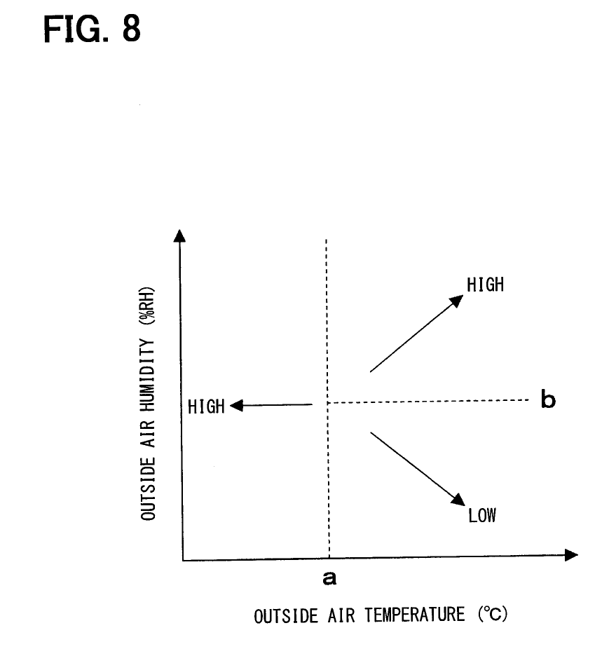

A second embodiment of the present disclosure will now be described using FIG. 7 and FIG. 8. A description will be omitted or given simply for portions substantially same as counterparts in the first embodiment above, and the following will chiefly describe a portion different from the first embodiment above.

In the second embodiment, a flow rate ratio between the intercooler 21 and the EGR cooler 25 is varied by controlling the flow rate control valve 41 according to an outside air environment and an engine operating state by performing a flow rate control routine of FIG. 7 by an ECU 33.

In the flow rate control routine of FIG. 7, after an engine operating state, an outside air temperature, and an outside air humidity are obtained first in 301, advancement is made to 302, in which whether the engine 11 is in steady operation is determined.

When it is determined in 302 that the engine 11 is in steady operation, advancement is made to 303, in which the flow rate proportion of the EGR cooler 25 corresponding to the outside air temperature and the outside air humidity is calculated in reference to a map of the flow rate proportion of the EGR cooler 25 shown in FIG. 8. The map of the flow rate proportion of the EGR cooler 25 is created in advance from test data, design data, and so on, and pre-stored in a ROM of the ECU 33.

The map of the flow rate proportion of the EGR cooler 25 is set for the flow rate proportion of the EGR cooler 25 to increase (that is, for the flow rate proportion of the intercooler 21 to decrease) as an outside air temperature falls when the outside air temperature is in a low temperature region at or below a fourth threshold a. The map is also set for the flow rate proportion of the EGR cooler 25 to decrease (that is, for the flow rate proportion of the intercooler 21 to increase) as an outside air temperature rises and an outside air humidity falls when the outside air temperature is in a high temperature region above the fourth threshold a and the outside air humidity is in a low humidity region at or below a third threshold b. Further, the map is set for the flow rate proportion of the EGR cooler 25 to increase (that is, for the flow rate proportion of the intercooler 21 to decrease) as an outside air temperature rises and an outside air humidity rises when the outside air temperature is in the high temperature region above the fourth threshold a and the outside air humidity is in a high humidity region above the third threshold b to reduce the flow rate proportion of the intercooler 21 below the flow rate proportion in a high-temperature low-humidity state. The map of the flow rate proportion of the EGR cooler 25 may vary with an engine operating state (for example, an engine load and an engine speed).

After the flow rate proportion is calculated, advancement is made to 304, in which the flow rate control valve 41 is controlled to change the flow rate proportion of the EGR cooler 25 to the flow rate proportion calculated in 303.

Meanwhile, when it is determined in 302 that the engine 11 is not in steady operation, advancement is made to 305, in which whether the engine 11 is decelerating is determined. When it is determined in 305 that the engine 11 is decelerating, advancement is made to 306, in which the flow rate control valve 41 is controlled to increase the flow rate proportion of the EGR cooler 25 by a predetermined value. The flow rate control valve 41 is thus controlled by a feed forward control to reduce the flow rate proportion of the intercooler 21 when the engine 11 is decelerating.

By contrast, when it is determined in 305 that the engine 11 is not decelerating, advancement is made to 307, in which the flow rate control valve 41 is controlled to increase the flow rate proportion of the intercooler 21 by a predetermined value.

In the second embodiment described above, too, an effect same as the effect of the first embodiment above can be obtained.

### Third Embodiment

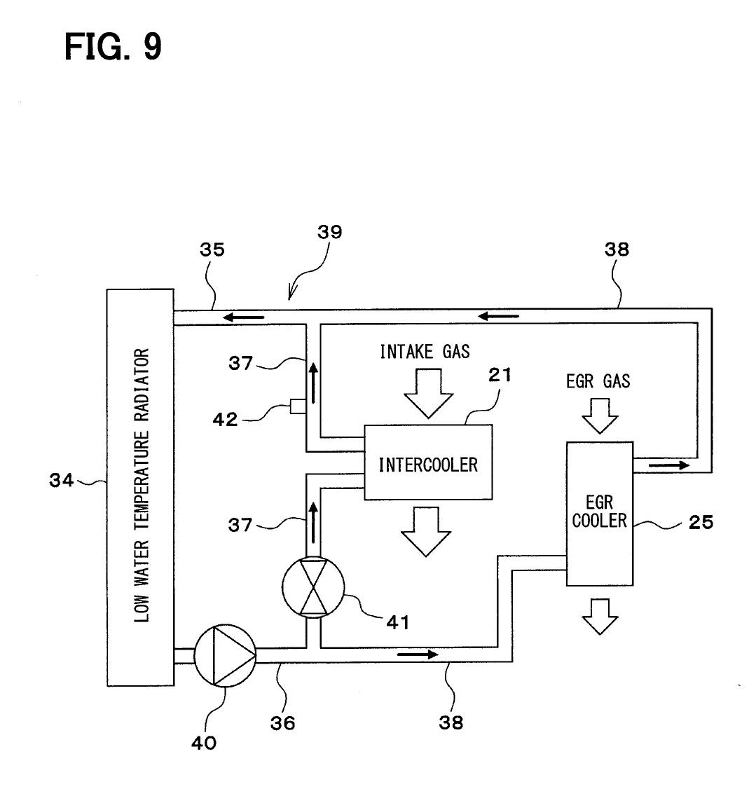

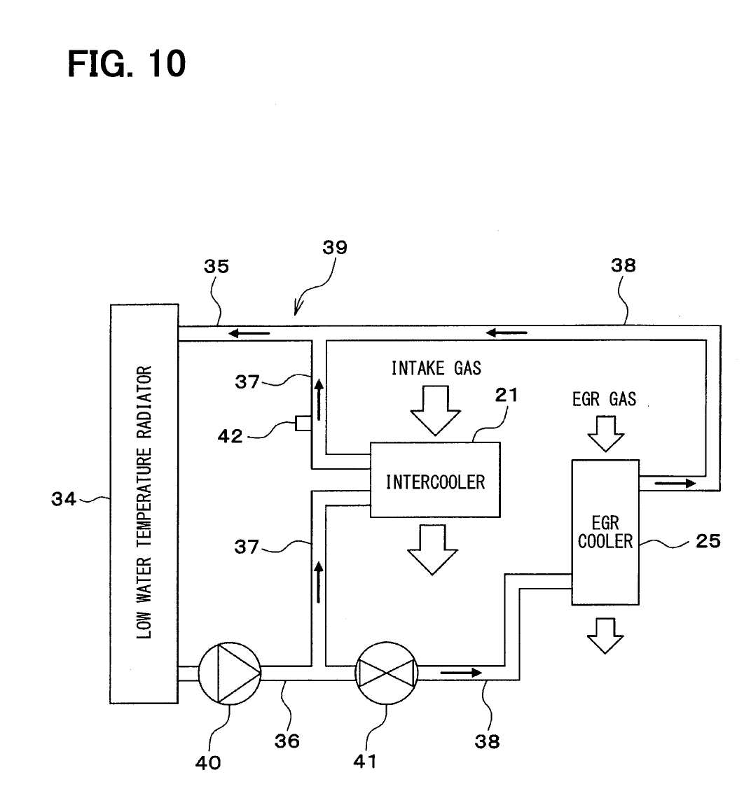

A third embodiment of the present disclosure will now be described using FIG. 9 and FIG. 10. A description will be omitted or given simply for portions substantially same as counterparts in the first embodiment above by giving the same reference numerals, and the following will chiefly describe a portion different from the first embodiment above.

In the third embodiment, as is shown in FIG. 9, the flow rate control valve 41 is provided to the intercooler channel 37 and a flow rate ratio between the intercooler 21 and the EGR cooler 25 is regulated by regulating a flow rate of the intercooler 21 by the flow rate control valve 41. Alternatively, as is shown in FIG. 10, the flow rate control valve 41 may be provided to the EGR cooler channel 38 to regulate a flow rate ratio between the intercooler 21 and the EGR cooler 25 by regulating a flow rate of the EGR cooler 25 by the flow rate control valve 41. In either case, a flow rate ratio between the intercooler 21 and the EGR cooler 25 can be varied in a reliable manner by the flow rate control valve 41. The flow rate control valve 41 may be provided to both of the intercooler channel 37 and the EGR cooler channel 38.

In the respective first through third embodiments above, functions performed by the ECU 33 (for example, a function as the control unit and a function as the fail-safe control unit), either in part or whole, may be formed of hardware using one or more than one IC or the like.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

1. A low temperature cooling device for an internal combustion engine, comprising:
an EGR device returning a part of an exhaust gas of an internal combustion engine to an intake passage as an EGR gas;
a low temperature coolant circuit circulating a coolant through an intercooler cooling an intake gas of the internal combustion engine and an EGR cooler cooling the EGR gas;
a flow rate control valve regulating a flow rate ratio between the coolant flowing into the intercooler and the coolant flowing into the EGR cooler; and
a control unit varying the flow rate ratio between the coolant flowing into the intercooler and the coolant flowing into the EGR cooler by controlling the flow rate control valve according to an outside air environment and an operating state of the internal combustion engine.

2. The low temperature cooling device for the internal combustion engine according to claim 1, wherein
the control unit uses an outside air temperature and an outside air humidity as the outside air environment.

3. The low temperature cooling device for the internal combustion engine according to claim 2, wherein
the control unit controls the flow rate control valve to increase a flow rate proportion of the coolant flowing into the EGR cooler as the outside air temperature falls in a low temperature state where the outside air temperature is in a predetermined low temperature region.

4. The low temperature cooling device for the internal combustion engine according to claim 2, wherein
the control unit controls the flow rate control valve to increase a flow rate proportion of the coolant flowing into the intercooler as the outside air temperature rises in a high-temperature low-humidity state where the outside air temperature is in a predetermined high temperature region and the outside air humidity is in a predetermined low humidity region.

5. The low temperature cooling device for the internal combustion engine according to claim 4, wherein
the control unit controls the flow rate control valve to reduce the flow rate proportion of the coolant flowing into the intercooler in a high-temperature high-humidity state where the outside air temperature is in the high temperature region and the outside air humidity is in a predetermined high humidity region below the flow rate proportion in the high-temperature and low-humidity state.

6. The low temperature cooling device for the internal combustion engine according to claim 1, wherein
the control unit regulates the flow rate proportion of the coolant flowing into the intercooler by a feed forward control according to the operating state of the internal combustion engine.

7. The low temperature cooling device for the internal combustion engine according to claim 1, wherein
the low temperature coolant circuit has an intercooler channel configured to circulate the coolant through the intercooler and an EGR cooler channel configured to circulate the coolant through the EGR cooler,
the intercooler channel and the EGR cooler channel are connected in parallel, and
the flow rate control valve is located at a branch point of the intercooler channel and the EGR cooler channel.

8. The low temperature cooling device for the internal combustion engine according to claim 1, wherein
the low temperature coolant circuit has an intercooler channel configured to circulate the coolant through the intercooler and an EGR cooler channel configured to circulate the coolant through the EGR cooler;
the intercooler channel and the EGR cooler channel are connected in parallel; and
the flow rate control valve is located at least one of the intercooler channel and the EGR cooler channel.

9. The low temperature cooling device for the internal combustion engine according to claim 1, further comprising:
a fail-safe control unit determining an abnormality in the low temperature coolant circuit and inhibiting the EGR gas from flowing back when at least one of a temperature of the intake gas which has passed through the intercooler and a temperature of the EGR gas which has passed through the EGR cooler is out of a predetermined normal range.

10. The low temperature cooling device for the internal combustion engine according to claim 1, wherein
the flow rate control valve has a function of returning to a state in which the flow rate proportion of the coolant flowing into the intercooler reaches a maximum when energization is stopped; and
the low temperature cooling device further comprises a fail-safe control unit stopping energization to the flow rate control valve and inhibiting the EGR gas from flowing back when an electric abnormality in the flow rate control valve is determined.

11. The low temperature cooling device for the internal combustion engine according to claim 1, further comprising:
a separator separating and collecting condensate water in the EGR gas which has passed through the EGR cooler; and
an EGR heater heating the EGR gas which has passed through the separator.
